(19) United States
(12) Patent Application Publication
(10) Pub. No.: US 2012/0247068 A1
(43) Pub. Date: Oct. 4, 2012

(54) METHOD AND APPARATUS FOR CARRIER

(76) Inventor: Joseph N. Laurita, Wayne, NJ (US)

(21) Appl. No.: 13/431,865

(22) Filed: Mar. 27, 2012

(51) Int. Cl. B65D 6/26; B65B 5/06; B23P 17/00

(52) U.S. Cl. 53/458; 206/427; 29/428

(57) ABSTRACT

An apparatus is provided for transporting a plurality of beverage containers. The apparatus may include first, second, third, and fourth sides, and a floor. The first, second, third, and fourth sides may be attached to the floor so that the first second, third and fourth sides can pivot with respect to the floor, and so that each can be placed in a first state in which each is parallel with respect to the floor and in a second state in which each is at a ninety degree angle with respect to the floor. At least one of the first, second, third, and fourth sides may have a bottom protrusion which can be adhered to the floor in the second state, to hold at least one of the first, second, third, and fourth sides in the second state.

### FIELD OF THE INVENTION

This invention relates to improved methods and apparatus concerning carriers.

### BACKGROUND OF THE INVENTION

Milk carriers or cases, such as case or carrier 100 shown in FIG. 1A, in their present form present many problems in the dairy industry as well as the beverage industries. The milk carriers or cases are typically molded or made as a box—four side sides and a bottom, as shown in FIG. 1A,—and this restricts handling and storage as well as transportation.

The molds and tooling that are needed to manufacture these known cases or carriers are complicated, expensive and require costly machinery necessary to produce these cases or carriers at low production cycles. Distortion and dimensional problems restrict the machine cycles as well as plastics or materials being used. Beverage and dairy industries are reluctant to change because their processing lines are complicated and changing would incur tremendous costs.

### SUMMARY OF THE INVENTION

In at least one embodiment an apparatus or carrier is provided for transporting a plurality of beverage containers. The apparatus may include first, second, third, and fourth sides; and a floor. The first, second, third, and fourth sides may be attached to the floor so that the first second, third and fourth sides can pivot with respect to the floor, and so that each of the first, second, third, and fourth sides can be placed in a first state in which each of the first, second, third, and fourth sides are substantially parallel with respect to the floor and in a second state in which each of the first, second, third, and fourth sides are substantially at a ninety degree angle with respect to the floor. In at least one embodiment, at least one of the first, second, third, and fourth sides has a bottom protrusion which can be adhered to the floor in the second state, to hold at least one of the first, second, third, and fourth sides in the second state. In at least one embodiment, each of the first, second, third, and fourth sides has a bottom protrusion which can be adhered to the floor in the second state, to hold the first, second, third, and fourth sides, respectively, in the second state.

In at least one embodiment, at least one of the first, second, third, and fourth sides has a first protrusion which can be adhered to one of the other sides of the first, second, third, and fourth sides to hold at least one of the first, the second, the third, and the fourth sides in the second state. In at least one embodiment, each of the first, second, third, and fourth sides has a first protrusion which can be adhered to one of the other sides of the first, second, third, and fourth sides to hold the first, the second, the third, and the fourth sides, respectively, to one of the other sides of the first, second, third, and fourth sides in the second state.

In at least one embodiment, the at least one of the first, second, third, and fourth sides which has a first protrusion also has a second protrusion which is opposite the first protrusion, and which can be adhered to one of the other sides of the first, second, third, and fourth sides to hold at least one of the first, the second, the third, and the fourth sides in the second state. In at least one embodiment, each of the first, second, third, and fourth sides has a second protrusion, which is opposite the first protrusion and which can be adhered to one of the other sides of the first, second, third, and fourth sides to hold the first, the second, the third, and the fourth sides, respectively, to one of the other sides of the first, second, third, and fourth sides in the second state.

In at least one embodiment, a method is provided which includes the steps of forming a plurality of carriers, placing each of the plurality of carriers in a first state, stacking the plurality of carriers on top of one another in a transportation vehicle, while each of the plurality of carriers is in the first state. Each of the plurality of carriers may be an apparatus for transporting a plurality of beverage carriers configured as previously described.

The method may further include, after stacking the plurality of carriers on top of one another in the transportation vehicle, transporting the plurality of containers from one geographic location to another geographic location. The method may also include thereafter forming each of the plurality of carriers into the second state, and thereafter placing a plurality of beverage containers into each of the plurality of carriers.

### BRIEF DESCRIPTION OF THE DRAWINGS

FIG. 1A shows a perspective view of a carrier of the prior art;

FIG. 1B shows a perspective view of a typical known milk carton of the prior art;

FIG. 10 shows a perspective view of a plurality of typical known milk cartons inserted into the carrier of FIG. 1A;

FIG. 2A shows a top, front, right side perspective view of a foldable carrier in accordance with an embodiment of the present invention with the foldable carrier shown in an upright and assembled state;

FIG. 2B shows a top, rear, left side perspective view of the carrier of FIG. 2A in the upright and assembled state;

FIG. 3A shows a left side view of the carrier of FIG. 2A in the upright and assembled state;

FIG. 3B shows a right side view of the carrier of FIG. 2A in the upright and assembled state;

FIG. 3C shows a front view of the carrier of FIG. 2A in the upright and assembled state;

FIG. 3D shows a rear view of the carrier of FIG. 2A in the upright and assembled state;

FIG. 4A shows a top view of the carrier of FIG. 2A in a collapsed state;

FIG. 4B shows a bottom view of the carrier of FIG. 2A in a collapsed state;

FIG. 5A shows a perspective view of the left side of the carrier of FIG. 2A;

FIG. 5B shows a perspective view of the right side of the carrier of FIG. 2A;

FIG. 5C shows a perspective view of the front of the carrier of FIG. 2A;

FIG. 5D shows a perspective view of the rear of the carrier of FIG. 2A;

FIG. 6 shows a top, front, right side perspective view of the carrier of FIG. 2A in the upright and assembled state with a plurality of milk cartons inserted inside a chamber of the carrier of FIG. 2A;

FIG. 7A shows a rear view of the carrier of FIG. 2A in a flattened or collapsed state;

FIG. 7B shows a front view of the carrier of FIG. 2A in a flattened or collapsed state;

FIG. 7C shows a left side view of the carrier of FIG. 2A in a flattened or collapsed state;

FIG. 7D shows a right side view of the carrier of FIG. 2A in a flattened or collapsed state;

FIG. 8A shows a rear view of the carrier of FIG. 2A in a flattened state, along with components for changing the carrier from the flattened state to the upright and assembled state;

FIG. 8B shows a right side view of the carrier of FIG. 2A in a flattened state, along with components for changing the carrier from the flattened state to the upright and assembled state;

FIG. 8C shows a rear view of the carrier of FIG. 2A in an upright and assembled state, along with components for changing the carrier from the flattened state to the upright and assembled state;

FIG. 8D shows a right side view of the carrier of FIG. 2A in an upright and assembled state, along with components for changing the carrier from the flattened state to the upright and assembled state;

FIG. 9A shows a perspective view of a portion of the carrier of FIG. 2A; and

FIG. 9B shows a perspective view of another portion of the carrier of FIG. 2A.

### DETAILED DESCRIPTION OF THE DRAWINGS

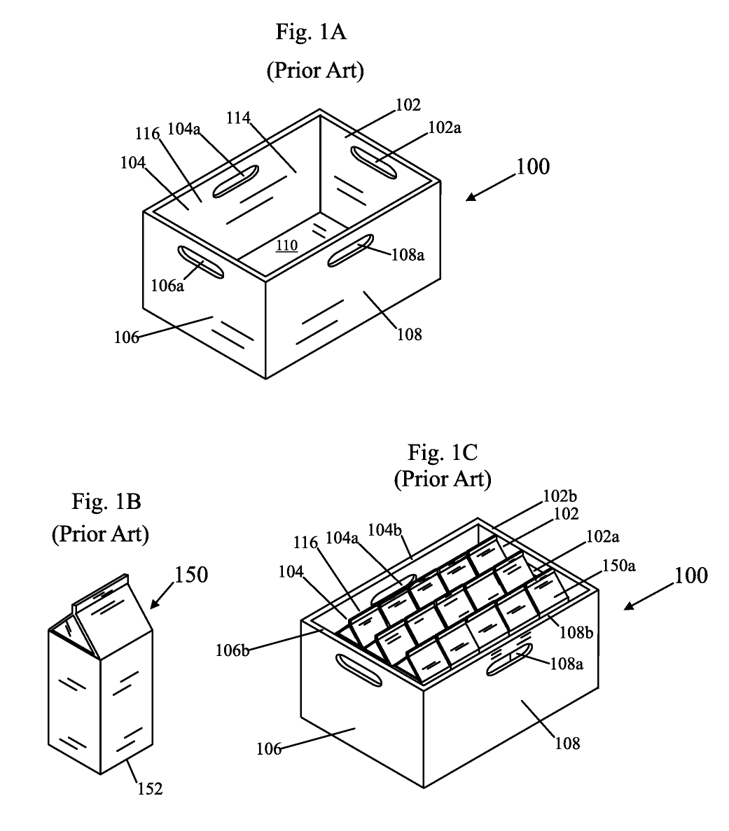

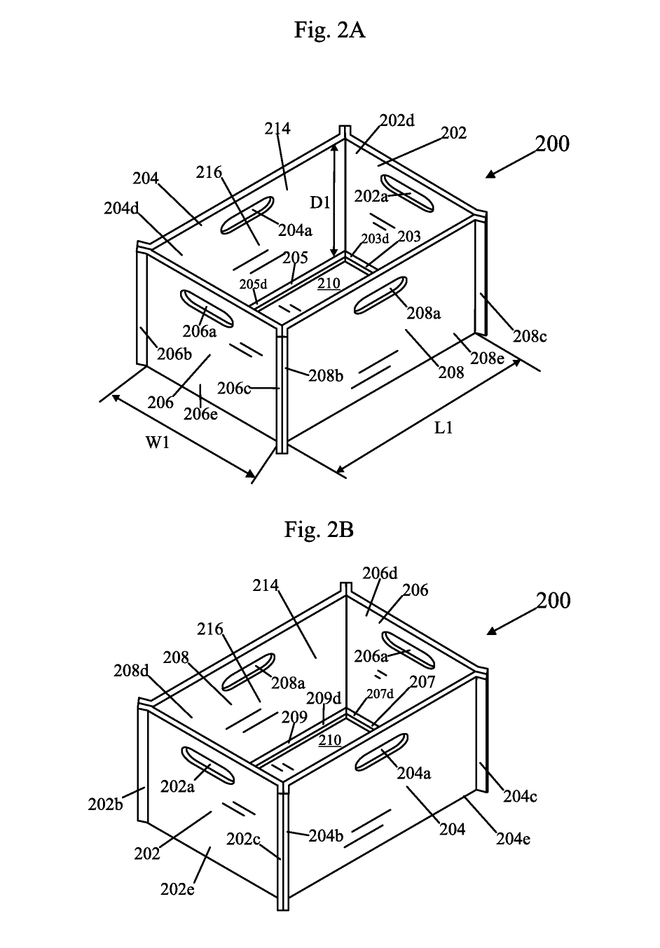

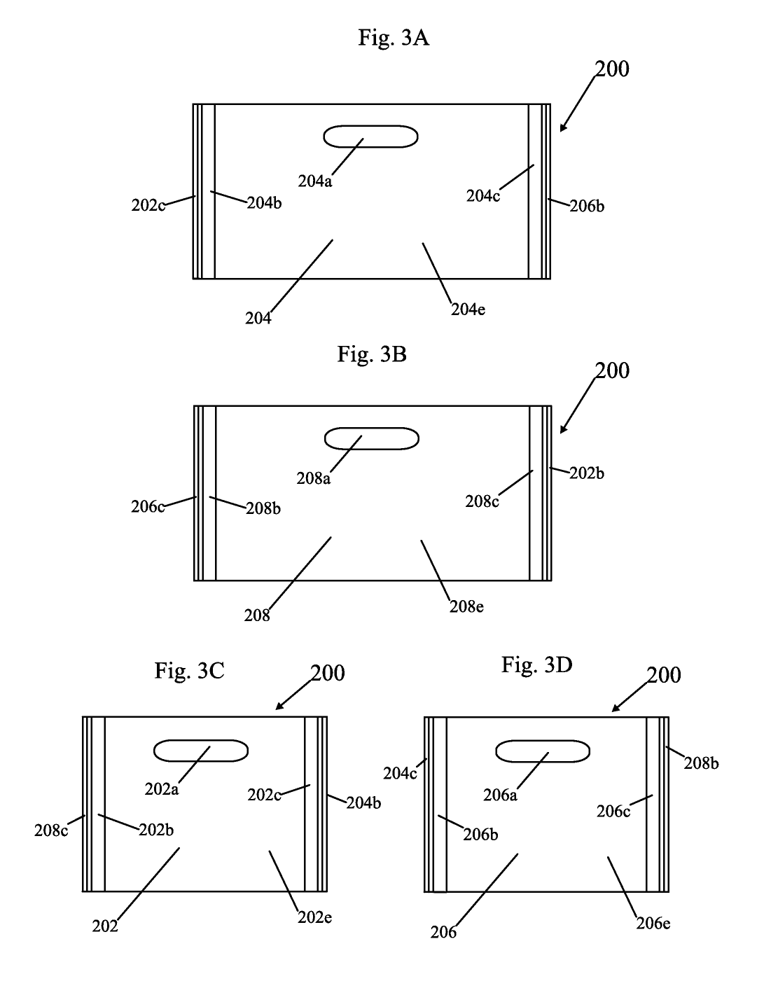

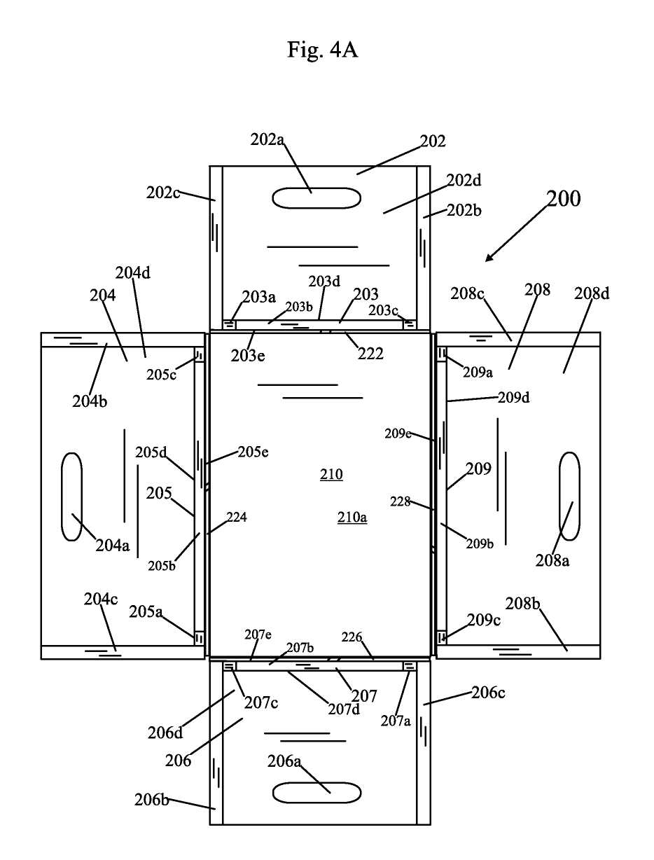

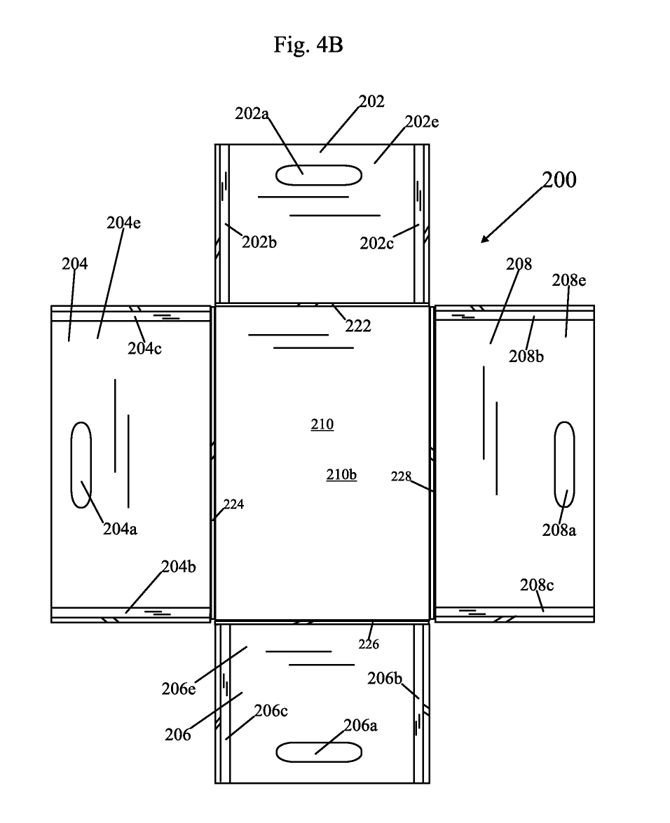

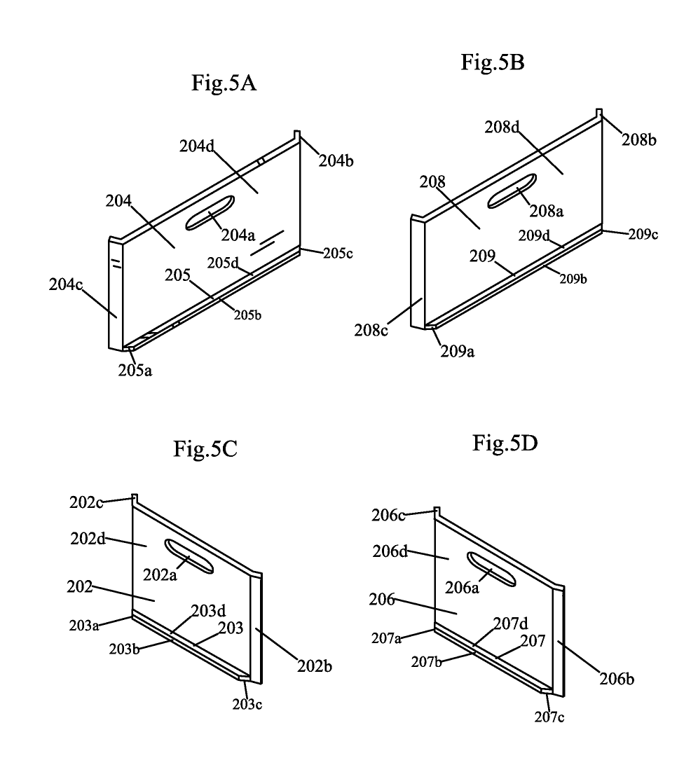

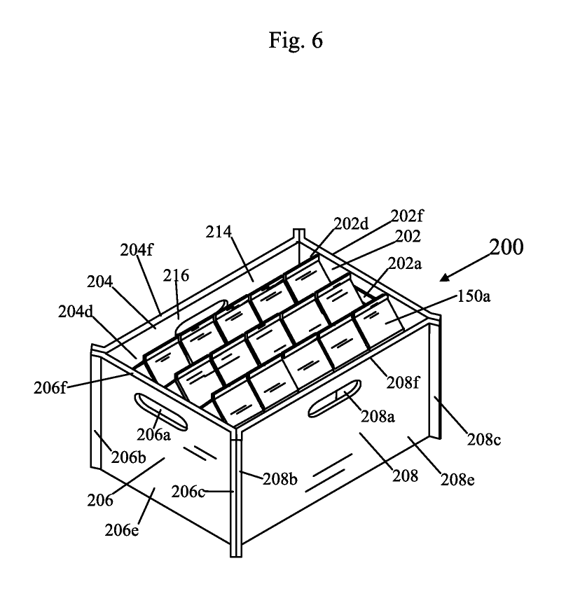

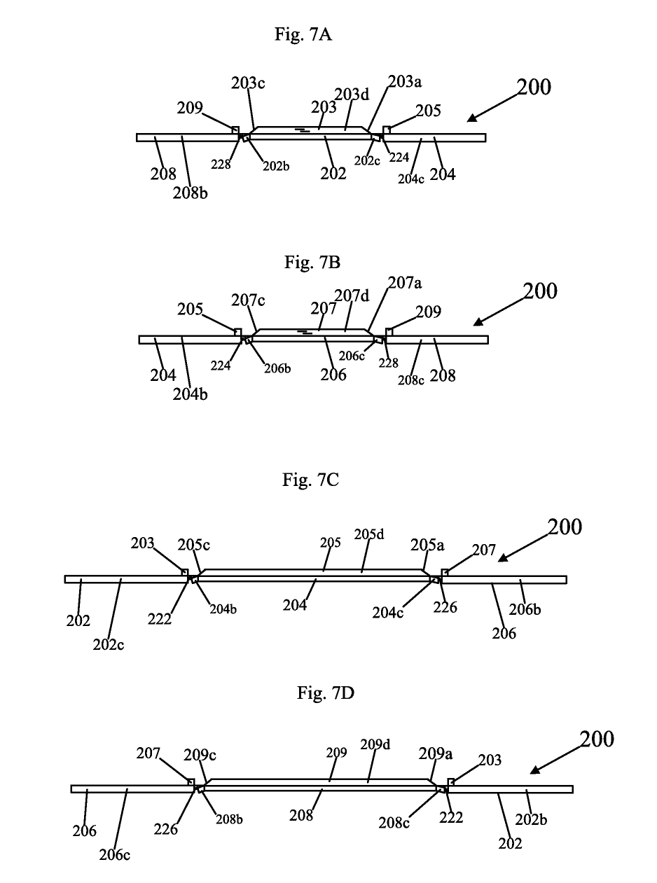

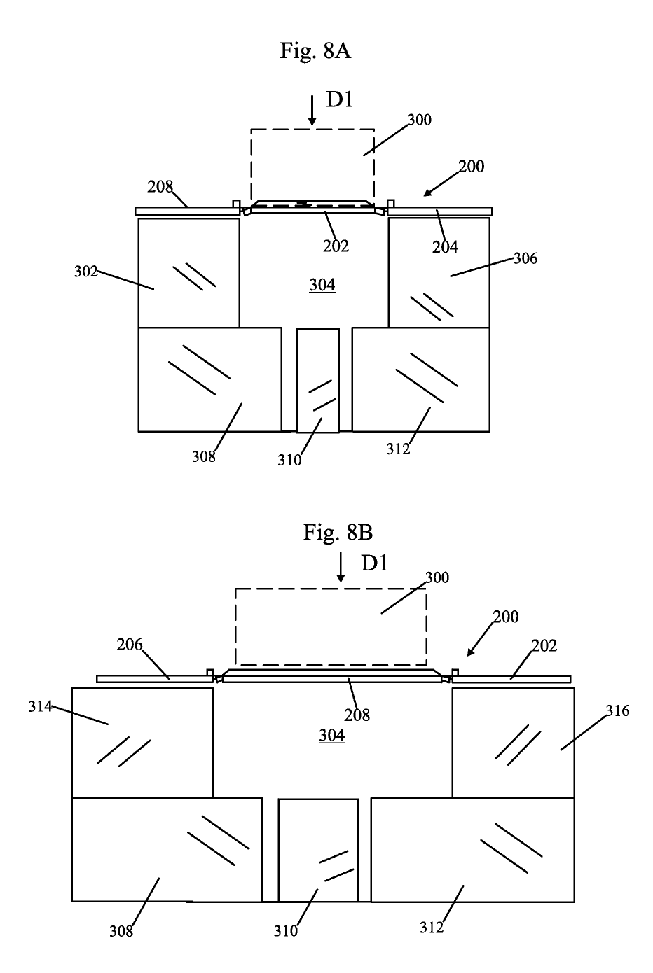

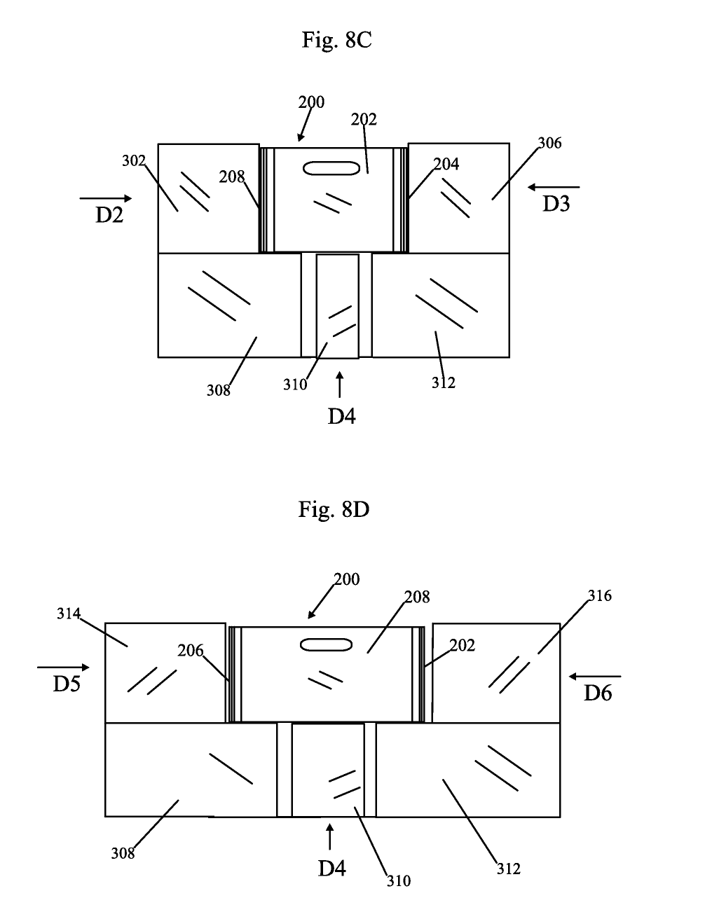

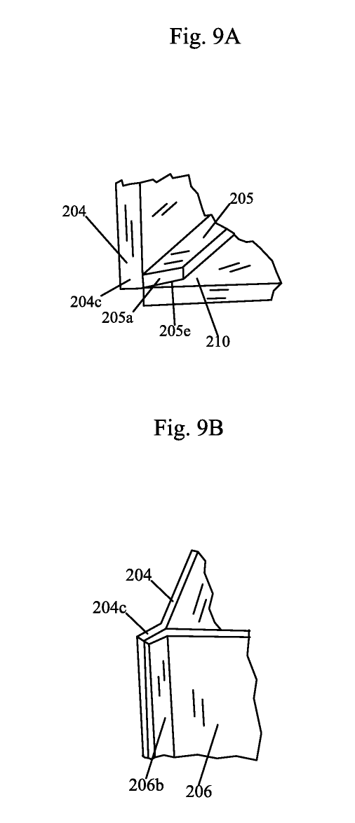

FIG. 1A shows a perspective view of a carrier 100 of the prior art. FIG. 1B shows a perspective view of a typical known milk carton 150 of the prior art. FIG. 10 shows a perspective view of a plurality of typical known milk cartons 150a, 150b, 150c, and 150d, each of which may be identical to milk carton 150 and each of which may include milk inside, with the cartons 150a-d inserted into the carrier 100 of FIG. 1A. The carrier 100 may have sides 102, 104, 106, and 108 and bottom 110, each of which may be made of a hard, rigid material, such as a hard plastic, or wood. The side 102 is typically rigidly fixed to the sides 104 and 108, and to the bottom or floor 110, so that the side 102 cannot be changed in orientation with respect to the sides 104 and 108 and the floor 110, without breaking the carrier 100. The side 104 is typically rigidly fixed to the sides 102 and 106, and to the bottom or floor 110, so that the side 104 cannot be changed in orientation with respect to the sides 102 and 106 and the floor 110, without breaking the carrier 100. The side 106 is typically rigidly fixed to the sides 104 and 108, and to the bottom or floor 110, so that the side 106 cannot be changed in orientation with respect to the sides 104 and 108 and the floor 110, without breaking the carrier 100. The side 108 is typically rigidly fixed to the sides 102 and 106, and to the bottom or floor 110, so that the side 108 cannot be changed in orientation with respect to the sides 102 and 106 and the floor 110, without breaking the carrier 100.

Referring to FIGS. 1A and 10, the sides 102, 104, 106, and 108, along with the bottom or floor 110 enclose and/or surround a chamber 116 through an opening 114 at the top of the carrier 100. The plurality of milk cartons 150a can be inserted through the opening 114 into the chamber 116 and rested on the floor 110. The carrier 100 can be lifted by the handles or openings 102a, 104a, 106a, and/or 108a Each of the milk cartons of the plurality of milk cartons 150a may be identical to milk carton 150 shown in FIG. 1B. Typically, all of the milk cartons 150a sit on the floor or surface 110, so that they are all below the tops 102b, 104b, 106b, and 108b of the carrier 100. Thus another carrier, identical to 100 can be placed on top of the carrier 100 without contacting the milk cartons 150a Typically the milk cartons 150a utilize the substantially the entire chamber 116, so that the milk cartons 150a snugly fit into the chamber 116.

FIG. 2A shows a top, front, right side perspective view of a foldable carrier 200 in accordance with an embodiment of the present invention with the foldable or collapsible carrier 200 shown in an upright and assembled state. FIG. 2B shows a top, rear, left side perspective view of the carrier 200 in the upright and assembled state. FIGS. 3A-D show a left side, right side, front, and rear views of the carrier 200 in the upright and assembled state. FIG. 4A shows a top view of the carrier 200 in a collapsed state. FIG. 4B shows a bottom view of the carrier 200 in a collapsed state. FIGS. 5A-D show left side, right side, front, and rear perspective views of the carrier 200 of FIG. 2A.

Referring to FIGS. 2A-5D, the carrier 200 includes sides 202, 204, 206, and 208, and bottom or floor 210. The sides 202, 204, 206, and 208 include openings or handles 202a, 204a, 206a, and 208a, respectively. Each of the sides 202, 204, 206, and 208 also include a flat panel having an inner surface and an outer surface. Side 202 has a flat panel having an inner surface 202d shown in FIG. 5C and an outer surface 202e shown in FIG. 3C. Side 204 has a flat panel having an inner surface 204d shown in FIG. 5A and an outer surface 204e shown in FIG. 3A. Side 206 has a flat panel having an inner surface 206d shown in FIG. 5D and an outer surface 206e shown in FIG. 3D. Side 208 has a flat panel having an inner surface 208d shown in FIG. 5B and an outer surface 208e shown in FIG. 3B.

Each of the sides 202, 204, 206, and 208 have left and right protrusion portions. Side 202 has a left protrusion portion 202b and a right protrusion portion 202c shown by FIGS. 5C, 4B, and 3C. Side 204 has a left protrusion portion 204b and a right protrusion portion 204c shown by FIGS. 5A, 4B, and 3A. Side 206 has a left protrusion portion 206b and a right protrusion portion 206c shown by FIGS. 5D, 4B, and 3D. Side 208 has a left protrusion portion 208b and a right protrusion portion 208c shown by FIGS. 5B, 4B, and 3B.

Each of the sides 202, 204, 206, and 208 have bottom protrusion portions. Side 202 has a bottom protrusion 203 shown in FIGS. 2A, 4A, 5C. The bottom protrusion 203 has a top surface 203d, slanted or tapered surfaces 203a and 203c, and straight surface 203b Side 204 has a bottom protrusion 205 shown in FIGS. 2A, 4A, 5A. The bottom protrusion 205 has a top surface 205d, slanted or tapered surfaces 205a and 205c, and straight surface 205b Side 206 has a bottom protrusion 207 shown in FIGS. 2B, 4A, 5D. The bottom protrusion 207 has a top surface 207d, slanted or tapered surfaces 207a and 207c, and straight surface 207b Side 208 has a bottom protrusion 209 shown in FIGS. 2B, 4A, 5B. The bottom protrusion 209 has a top surface 209d, slanted or tapered surfaces 209a and 209c, and straight surface 209b.

Each of the sides 202, 204, 206, and 208 may be made of a hard rigid material, such as a hard plastic, composition, fiber resin, or any material that can form the carrier as configured or as designed. The sides 202, 204, 206, and 208 may be attached to the bottom or floor 210 by hinges or flexible foldable members 222, 224, 226, and 228, respectively, as shown in FIG. 4A, or by any flexible means. The hinges or flexible foldable members 222, 224, 226, and 228 allow the carrier 200 to be placed in a collapsed or folded state such as shown by FIGS. 4A and 4B.

FIG. 6 shows a top, front, right side perspective view of the carrier 200 in the upright and assembled state with the plurality of milk cartons 150a inserted through the opening 214 and inside the chamber 216 of the carrier 200, so that the milk cartons 150a sit on and are supported by the floor or bottom 210. Each of the milk cartons of the plurality of milk cartons 150a may be identical to milk carton 150 shown in FIG. 1B. The milk cartons 150a sit on the floor or surface 210, so that they are all below the tops 202f, 204f, 206f, and 208f shown in FIG. 6, of the assembled or upright carrier 200. Thus another carrier, identical to 200 can be placed on top of the carrier 200 without contacting the milk cartons 150a The milk cartons 150a utilize the substantially the entire chamber 216, so that the milk cartons 150a snugly fit into the chamber 216. Each of the milk cartons 150a may be quarts, half gallon, or gallon milk cartons. Alternatively, other types of milk containers, such as bottles, may be placed in carrier 200 and carrier 200 may be sized appropriately, so that a plurality of milk containers fits snugly within the walls of the carrier 200 without exceeding the tops 202f, 204f, 206f, and 208f while sitting on the floor or surface 210.

FIGS. 7A, 7B, 7C, and 7D show rear, front, left side, and right side views, respectively, of the carrier 200 in a flattened or collapsed state.

FIG. 8A shows a rear view of the carrier 200 in a flattened state, along with components for changing the carrier 200 from the flattened state to the upright and assembled state. FIG. 8B shows a right side view of the carrier 200 in a flattened state, along with components for changing the carrier 200 from the flattened state to the upright and assembled state. Components for changing the state of carrier 200 from flattened to upright and assembled may include a solid plunger or solid member 300, shown by dashed lines in FIGS. 8A and 8B, solid plungers or solid members 302 and 306 shown in FIG. 8A, and solid plungers or solid members 314 and 316 shown in FIG. 8B. Base members 308 and 312 may support the solid plungers 302, 306, 314, and 316, while allowing the plungers 302, 306, 314, and 316 to slide. A solid plunger or member 310 is also provided and shown in FIGS. 8A and 8B.

In operation, an adhesive may be placed on portions 202b, 202c, 204b, 204c, 206b, 206c, 208b, 208c, 203a, 203c, 205a, 205c, 207a, 207c, 209a, and 209c shown in FIG. 4A. Next the solid plunger 300 may push on the inside surface 210a shown in FIG. 4A, of the floor 210 of the carrier 200. The solid plunger 300 has an area which contacts the inside surface 210a of the floor 210 but which does not contact or overlap the sides 202, 204, 206, and 208 or the hinges 222, 224, 226, and 228. The solid plunger pushes on the inside surface 210a in the direction D1, shown in FIG. 8A. This causes the floor 210 to go down into a chamber or cavity 304 between members or plungers 302, 306, 314, and 316. This also causes the sides 202, 204, 206, and 208 to pivot about hinges 222, 224, 226, and 228, respectively. The plunger 300 pushes the floor 210 down into the chamber 304 until a exterior bottom surface 210b of the floor 210 shown in FIG. 4B comes in contact with the members 308 and 312. When the bottom surface 210b of the floor 210 has contacted the members 308 and 312, the sides 202, 204, 206, and 208 are upright and at a ninety degree angle with respect to the floor 210. In addition, the protrusions or portions 202c and 204b, 202b and 208c, 208b and 206c, 206b and 204c, as well as 204b and 202c are adhered together by adhesive, solvent, or mechanical means. Also, the portions 203c and 209a, 209c and 207a, 207c and 205a, as well as 205c and 203a, are adhered together by adhesive. In addition, the members 203, 205, 207, and 209 may be adhered to the inner surface 210a of the floor 210 by adhesives on the sides opposite sides 203d, 205d, 207d, and 209d.

The carrier 200 may be further pressed together into its assembled and upright state in the directions D2 and D3 shown in FIG. 8C and in the directions D5 and D6 shown in FIG. 8D, by the plungers or members 302, 306, 314, and 316, respectively. The plungers or members 302, 304, 314, and 316 may press on sides 208, 204, 206, and 202, respectively, to press the carrier 200 into a solid upright form.

After the carrier 200 has been pressed into the upright and assembled form, the plunger 310 may push the carrier 200 out of the chamber 304 to eject the carrier 200 in the upright and assembled form shown in FIGS. 2A and 2B.

In operation, the carrier 200 may be machine molded in the collapsed or flattened state of FIGS. 4A and 4B. The carrier 200 may entirely or substantially be made of one material, such as a plastic, composition, fiberglass or any material that can form the carrier 200 as configured or as designed.

The sides 202, 204, 206 and 208 may then be folded up with respect to the bottom 210 to place the sides at a ninety degree angle with respect to the bottom 210. In this state, the protrusions or flared portion 204b and 202c, 204c and 206b, 208b and 206c, and 208c and 202b, can be fixed to each other by an adhesive placed on either of their surfaces. For example, an adhesive may be placed on flared portion 204b which is then attached and fixed by the adhesive to portion 202c, to keep the sides 202 and 204 upright.

In addition, an adhesive may be used to attach and/or fix, portion 203c to portion 209a, portion 209c to portion 207a, portion 206c to portion 205a, and portion 205c to portion 203a, to further strengthen the carrier or case 200 in its upright and assembled state of FIGS. 2A and 2B.

One or more embodiments of the present invention do not require major changes or costs for milk packagers. The cost of producing, and tooling for the carrier or case 200 in accordance with an embodiment of the present invention is significantly less than that required to produce tooling for the carrier 100 of the prior art, for at least the reason that the carrier 200 is made in a flat state. One or more embodiments of the present invention, allow an operator to reduce machinery size needed to run tooling for carrier 200 versus tooling for old carrier 100. Tooling for case or carrier 200, allows for shrinkage adjustments—making it possible to run different materials giving purchasing advantages, whereas a mold for carrier 100 does not allow for shrinkage adjustments, this is because mold sizes for old carrier 100 are fixed and cannot be adjusted.

In addition, distortion problems will be minimized because when the carrier 200 is in a flat state as shown in FIGS. 7A-8B, stresses are reduced.

If a mold for carrier 200 is run off dairy on beverage premises, transportation costs will reduce dramatically. Now a fifty-three foot trailer can hold approximately three thousand four hundred cases or carriers, in a collapsed form such as shown in FIG. 4A, each of which is identical to 200 or substantially similar.

New case or carrier, such as carrier 200, will allow more carriers (identical to 200) to be shipped by a truck, train, or cargo carrying ship, because in the flat state shown in FIGS. 7A-8B, more carriers 200 can fit into a cargo container, then for an old carrier 100 which can not be placed in a flat state.

The carrier or case 200 can be made of a disposable and/or recyclable material, which can reduce costs and handling.

Costs for shipping, and/or transporting cases, identical to case or carrier 200 cross country, allows possible expanding market because trailers will hold more cases or carriers 200 in the flat state, then they can hold old carriers 100 in the non-flat state.

By using one or more embodiments of the present application, dairy or beverage industries or companies will have the following options. The dairy or company may buy a system and apparatus (entire package) for manufacturing cases or carriers, identical to case or carrier 200, and the system may be installed on premises of the dairy or beverage company. Thus no outside suppliers may be needed, in at least one embodiment.

Alternatively, the dairy or company, may have the carrier 200 molded in the flattened form of FIGS. 4A and 4B, off premises and then sides 202, 204, 206, and 208 can be folded upwards and then the protrusions 204b and 202c, 202b and 208c, 208b and 206c, 206c and 204c, can be sealed together by an adhesive to fix the carrier 200 in the upright and assembled state of FIGS. 2A and 2B. The assembling or changing of the carrier 200 from the flattened or collapsed state of FIGS. 4A and 4B to the assembled and upright state of FIGS. 2A and 2B can be done in house by a company on a production line, which can give a company total control and allow a company to assembled carriers 200 in the upright and assembled state as needed.

One or more embodiments of the present invention reduce case or carrier handling and storage costs significantly. Any of the exterior surfaces of the sides 202, 204, 206, and 208 can be used for advertising, and ads can be easily placed on the carrier 200 when it is in the flattened or collapsed state of FIGS. 4A and 4B. The weight of the carrier 200 may also be made less than the weight of carrier 100 of the prior art.

FIG. 9A shows a perspective view of a portion of the carrier 200. In FIG. 9A, parts of the side 204, the protrusion 205, and the bottom 210 are shown. The bottom surface 205e of the protrusion 205 can be welded to the bottom 210 or an adhesive such as a mechanical adhesive can be used to attach the bottom surface 205e of the protrusion 205 to the bottom 210. In a similar or identical manner, the bottom surfaces 203e, 207e, and 209e, whose location is shown by FIG. 4A, can be adhered or attached to the bottom 210 to place and/or fix the carrier 200 in the upright state of FIG. 2A.

FIG. 9B shows a perspective view of another portion of the carrier 200. FIG. 9B shows part of the sides 204 and 206 and part of protrusions 204c and 206b The protrusions 204c and 206b can be welded together or adhered together, such as by an adhesive, such as a mechanical adhesive. In a similar or identical manner, protrusions 204b and 202c, 202b, and 208c, and 208b and 206c, can be welded together or adhered together, such as by an adhesive, such as by a mechanical adhesive to place and/or fix the carrier 200 in the upright state of FIG. 2A.

In at least one embodiment, the carrier 200 may be exactly or substantially rectangular and may have a internal length (not including thicknesses of walls 206 and 202) of L1, which may be about seventeen and three quarters inches, a internal width of W1 (not including thicknesses of walls 204 and 208), which may be about twelve inches, and a internal depth (not including thickness of floor or bottom 210), D1, which may be about ten and one quarter inch as shown by FIG. 2A, when in an upright and assembled state. The dimensions will vary according to manufacturing standards, material shrinkage, and filling operation requirements.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus for transporting a plurality of beverage containers comprising:
first, second, third, and fourth sides;
a floor;
wherein the first, second, third, and fourth sides are attached to the floor so that the first second, third and fourth sides can pivot with respect to the floor, and so that each of the first, second, third, and fourth sides can be placed in a first state in which each of the first, second, third, and fourth sides are substantially parallel with respect to the floor and in a second state in which each of the first, second, third, and fourth sides are substantially at a ninety degree angle with respect to the floor;
and wherein at least one of the first, second, third, and fourth sides has a bottom protrusion which can be adhered to the floor in the second state, to hold at least one of the first, second, third, and fourth sides in the second state.

2. The apparatus of claim 1 wherein
each of the first, second, third, and fourth sides has a bottom protrusion which can be adhered to the floor in the second state, to hold the first, second, third, and fourth sides, respectively, in the second state.

3. The apparatus of claim 1 wherein
at least one of the first, second, third, and fourth sides has a first protrusion which can be adhered to one of the other sides of the first, second, third, and fourth sides to hold at least one of the first, the second, the third, and the fourth sides in the second state.

4. The apparatus of claim 3 wherein
each of the first, second, third, and fourth sides has a first protrusion which can be adhered to one of the other sides of the first, second, third, and fourth sides to hold the first, the second, the third, and the fourth sides, respectively, to one of the other sides of the first, second, third, and fourth sides in the second state.

5. The apparatus of claim 3 wherein
the at least one of the first, second, third, and fourth sides which has a first protrusion also has a second protrusion which is opposite the first protrusion, and which can be adhered to one of the other sides of the first, second, third, and fourth sides to hold at least one of the first, the second, the third, and the fourth sides in the second state.

6. The apparatus of claim 4 wherein
each of the first, second, third, and fourth sides has a second protrusion, which is opposite the first protrusion and which can be adhered to one of the other sides of the first, second, third, and fourth sides to hold the first, the second, the third, and the fourth sides, respectively, to one of the other sides of the first, second, third, and fourth sides in the second state.

7. A method comprising the steps of:
forming a plurality of carriers;
placing each of the plurality of carriers in a first state;
stacking the plurality of carriers on top of one another in a transportation vehicle, while each of the plurality of carriers is in the first state;
wherein each of the plurality of carriers:
has first, second, third, and fourth sides; and
a floor;
wherein the first, second, third, and fourth sides are attached to the floor so that the first second, third and fourth sides can pivot with respect to the floor, and so that each of the first, second, third, and fourth sides can be placed in the first state in which each of the first, second, third, and fourth sides are parallel with respect to the floor and in a second state in which each of the first, second, third, and fourth sides are at a ninety degree angle with respect to the floor;
and wherein at least one of the first, second, third, and fourth sides has a bottom protrusion which can be adhered to the floor in the second state, to hold at least one of the first, second, third, and fourth sides in the second state.

8. The method of claim 7 wherein
each of the first, second, third, and fourth sides has a bottom protrusion which can be adhered to the floor in the second state, to hold the first, second, third, and fourth sides, respectively, in the second state.

9. The method of claim 7 wherein
at least one of the first, second, third, and fourth sides has a first protrusion which can be adhered to one of the other sides of the first, second, third, and fourth sides to hold at least one of the first, the second, the third, and the fourth sides in the second state.

10. The method of claim 9 wherein
each of the first, second, third, and fourth sides has a first protrusion which can be adhered to one of the other sides of the first, second, third, and fourth sides to hold the first, the second, the third, and the fourth sides, respectively, to one of the other sides of the first, second, third, and fourth sides in the second state.

11. The method of claim 9 wherein
the at least one of the first, second, third, and fourth sides which has a first protrusion also has a second protrusion which is opposite the first protrusion, and which can be adhered to one of the other sides of the first, second, third, and fourth sides to hold at least one of the first, the second, the third, and the fourth sides in the second state.

12. The method of claim 10 wherein
each of the first, second, third, and fourth sides has a second protrusion, which is opposite the first protrusion and which can be adhered to one of the other sides of the first, second, third, and fourth sides to hold the first, the second, the third, and the fourth sides, respectively, to one of the other sides of the first, second, third, and fourth sides in the second state.

13. The method of claim 6 further comprising
after stacking the plurality of carriers on top of one another in the transportation vehicle, transporting the plurality of containers from one geographic location to another geographic location;
thereafter forming each of the plurality of carriers into the second state; and
thereafter placing a plurality of beverage containers into each of the plurality of carriers.
